(19) United States
(12) Patent Application Publication
(10) Pub. No.: US 2022/0208013 A1
(43) Pub. Date: Jun. 30, 2022

(54) METHOD AND DEVICE FOR DETECTING ILLEGAL UNMANNED AERIAL VEHICLE USING RADIO WAVE WALL

(71) Applicant: Electronics and Telecommunications Research Institute, Daejeon (KR)

(72) Inventors: Young-il KIM, Daejeon (KR); Seong Hee PARK, Daejeon (KR); Soonyong SONG, Daejeon (KR); Geon Min YEO, Daejeon (KR); Il Woo LEE, Daejeon (KR); Wun-Cheol JEONG, Daejeon (KR); Tae-Wook HEO, Daejeon (KR)

(73) Assignee: Electronics and Telecommunications Research Institute, Daejeon (KR)

(21) Appl. No.: 17/483,120

(22) Filed: Sep. 23, 2021

(30) Foreign Application Priority Data
Dec. 4, 2020 (KR) 10-2020-0168769
Jul. 6, 2021 (KR) 10-2021-0088558

(51) Int. Cl. G08G 5/00; G01S 19/24; G01S 5/00

(52) U.S. Cl. CPC G08G 5/0069; G01S 5/0072; G01S 19/24; G08G 5/0078

(57) ABSTRACT

A method and device for detecting an illegal unmanned aerial vehicle (UAV) using a radio wave wall are provided. The method includes generating a radio wave wall between a plurality of reconnaissance UAVs that include a first reconnaissance UAV and second reconnaissance UAVs, using one or more wireless signals transmitted and received between the plurality of reconnaissance UAVs, and determining whether an illegal UAV enters the radio wave wall based on radio signal strengths of wireless signals received from the second reconnaissance UAVs.

### CROSS-REFERENCE TO RELATED APPLICATIONS

This application claims the benefit of Korean Patent Application No. 10-2020-0168769 filed on Dec. 4, 2020, and No. 10-2021-0088558 filed on Jul. 6, 2021, in the Korean Intellectual Property Office, the entire disclosures of which are incorporated herein by reference for all purposes.

### BACKGROUND

### 1. Field of the Invention

One or more example embodiments relate to a method and device for detecting an illegal unmanned aerial vehicle (UAV) using a radio wave wall.

### 2. Description of the Related Art

Recently, social unrest is being increased due to accidents caused by intrusion of small unmanned aerial vehicles (UAVs) into public places, and technology of remodeling small UAVs for military purposes is also developing.

Various technologies are being used to protect life and property from small UAVs, such as a detection technology through a radar, an image signal analysis-based detection technology, and a noise-based detection technology. However, if a UAV is small in size, it is difficult to detect the UAV.

To overcome such an issue, a noise sensor, an image sensor, and a radar sensor may be mounted on a reconnaissance UAV to expand a UAV detection range. However, when a detection sensor such as a noise sensor, an image sensor, and a radar sensor is used, a protected area may need to be monitored in real time.

### SUMMARY

Example embodiments provide a technology of configuring a radio wave wall by flying a reconnaissance unmanned aerial vehicle (UAV) including a wireless transceiver, and of detecting a UAV that enters the radio wave wall.

However, the technical aspects are not limited to the aforementioned aspects, and other technical aspects may be present.

According to an aspect, there is provided a method of detecting an illegal unmanned aerial vehicle (UAV), the method including generating a radio wave wall between a plurality of reconnaissance UAVs using one or more wireless signals transmitted and received between the plurality of reconnaissance UAVs, the plurality of reconnaissance UAVs including a first reconnaissance UAV and second reconnaissance UAVs, and determining whether an illegal UAV enters the radio wave wall based on radio signal strengths of wireless signals received from the second reconnaissance UAVs.

The method may further include controlling the first reconnaissance UAV to maximize the radio signal strengths of the wireless signals received from the second reconnaissance UAVs.

The controlling of the first reconnaissance UAV may include controlling the first reconnaissance UAV by forming a beam of an antenna mounted on the first reconnaissance UAV based on reception angles of the wireless signals received from the second reconnaissance UAVs.

The controlling of the first reconnaissance UAV may include controlling a flight attitude of the first reconnaissance UAV including a fixed antenna.

The controlling of the first reconnaissance UAV may include controlling a location of an antenna mounted on the first reconnaissance UAV based on the radio signal strengths of the wireless signals received from the second reconnaissance UAVs.

The determining of whether the illegal UAV enters the radio wave wall may include calculating an estimated distance based on information included in the wireless signals received from the second reconnaissance UAVs. The estimated distance may be a distance between the first reconnaissance UAV and each of the second reconnaissance UAVs.

The information may include at least one of location information of the second reconnaissance UAVs and unique pseudo-noise (PN) codes assigned to the second reconnaissance UAVs.

The determining of whether the illegal UAV enters the radio wave wall may further include measuring the radio signal strengths of the wireless signals received from the second reconnaissance UAVs.

The determining of whether the illegal UAV enters the radio wave wall may further include comparing a measured radio signal strength to a radio signal strength that is based on the estimated distance, and determining whether the illegal UAV enters the radio wave wall.

According to another aspect, there is provided a device for detecting an illegal UAV, the device including a memory configured to store at least one instruction, and a processor configured to execute the instruction, wherein when the instruction is executed, the processor is configured to generate a radio wave wall between a plurality of reconnaissance UAVs using one or more wireless signals transmitted and received between the plurality of reconnaissance UAVs, the plurality of reconnaissance UAVs including a first reconnaissance UAV and second reconnaissance UAVs, and to determine whether an illegal UAV enters the radio wave wall based on radio signal strengths of wireless signals received from the second reconnaissance UAVs.

The processor may be configured to control the first reconnaissance UAV to maximize the radio signal strengths of the wireless signals received from the second reconnaissance UAVs.

The processor may be configured to control the first reconnaissance UAV by forming a beam of an antenna mounted on the first reconnaissance UAV based on reception angles of the wireless signals received from the second reconnaissance UAVs.

The processor may be configured to control a flight attitude of the first reconnaissance UAV including a fixed antenna.

The processor may be configured to control a location of an antenna mounted on the first reconnaissance UAV based on the radio signal strengths of the wireless signals received from the second reconnaissance UAVs.

The processor may be configured to calculate an estimated distance based on information included in the wireless signals received from the second reconnaissance UAVs. The estimated distance may be a distance between the first reconnaissance UAV and each of the second reconnaissance UAVs.

The information may include at least one of location information of the second reconnaissance UAVs and unique PN codes assigned to the second reconnaissance UAVs.

The processor may be configured to measure the radio signal strengths of the wireless signals received from the second reconnaissance UAVs.

The processor may be configured to compare a measured radio signal strength to a radio signal strength that is based on the estimated distance, and to determine whether the illegal UAV enters the radio wave wall.

According to another aspect, there is provided a flight method of a reconnaissance UAV, the flight method including generating a radio wave wall between a plurality of reconnaissance UAVs using one or more wireless signals transmitted and received between the plurality of reconnaissance UAVs, the plurality of reconnaissance UAVs including a first reconnaissance UAV and second reconnaissance UAVs, and adjusting a distance between the first reconnaissance UAV and each of the second reconnaissance UAVs based on a radio signal strength of a wireless signal received from the first reconnaissance UAV to maintain the radio wave wall.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a block diagram illustrating a device for detecting an illegal unmanned aerial vehicle (UAV) according to an example embodiment;

FIG. 2A is a diagram illustrating an operation of reconnaissance UAVs to transmit and receive wireless signals;

FIG. 2B illustrates a radio wave wall generated based on wireless signals transmitted and received between reconnaissance UAVs;

FIGS. 3A and 3B are diagrams illustrating radio signal strengths of wireless signals based on a propagation path;

FIG. 4 illustrates an example of a reconnaissance UAV of FIG. 2A;

FIG. 5 is a flowchart illustrating a control operation of a reconnaissance UAV;

FIG. 6 is a diagram illustrating an operation of detecting an illegal UAV that enters a radio wave wall; and

FIG. 7 is a flowchart illustrating a flight method of reconnaissance UAVs.

### DETAILED DESCRIPTION

The following detailed structural or functional description is provided as an example only and various alterations and modifications may be made to the example embodiments. Here, the example embodiments are not construed as limited to the disclosure and should be understood to include all changes, equivalents, and replacements within the idea and the technical scope of the disclosure.

Terms, such as first, second, and the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

It should be noted that if it is described that one component is “connected”, “coupled”, or “joined” to another component, a third component may be “connected”, “coupled”, and “joined” between the first and second components, although the first component may be directly connected, coupled, or joined to the second component.

The singular forms “a”, “an”, and “the” are intended to include the plural forms as well, unless the context clearly indicates otherwise. It will be further understood that the terms “comprises/including” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Hereinafter, example embodiments will be described in detail with reference to the accompanying drawings. When describing the example embodiments with reference to the accompanying drawings, like reference numerals refer to like components and a repeated description related thereto will be omitted.

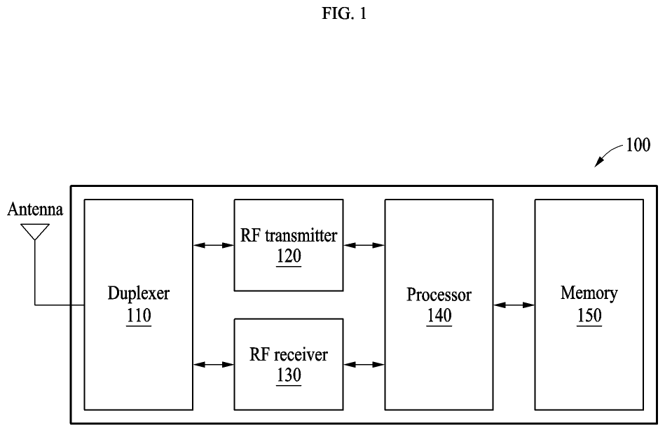

FIG. 1 is a block diagram illustrating a device for detecting an illegal unmanned aerial vehicle (UAV) according to an example embodiment.

An illegal UAV detection device 100 may detect an illegal UAV by transmitting and receiving a wireless signal to and from another illegal UAV detection device.

The illegal UAV detection device 100 may be attached to a reconnaissance UAV or implemented inside the reconnaissance UAV. The reconnaissance UAV may detect an illegal UAV while flying in a reconnaissance airspace.

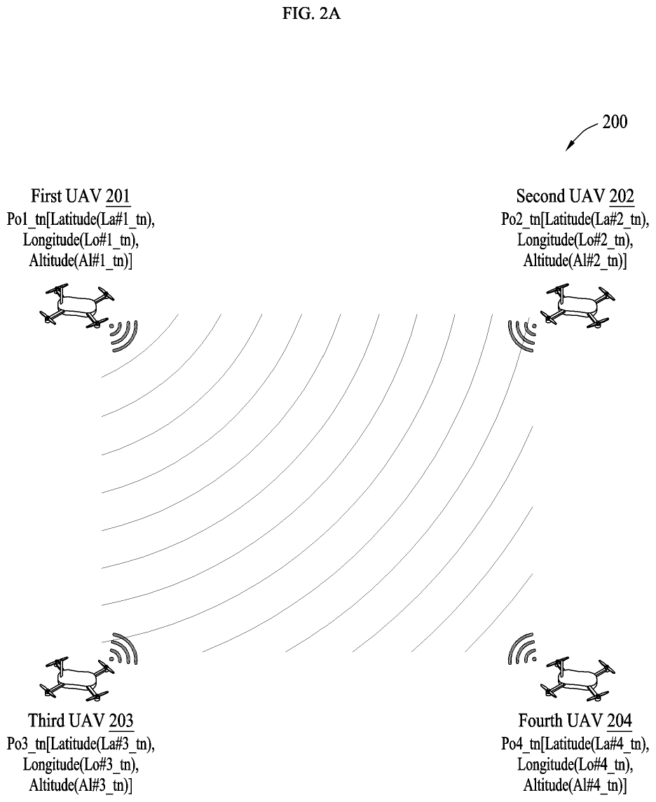

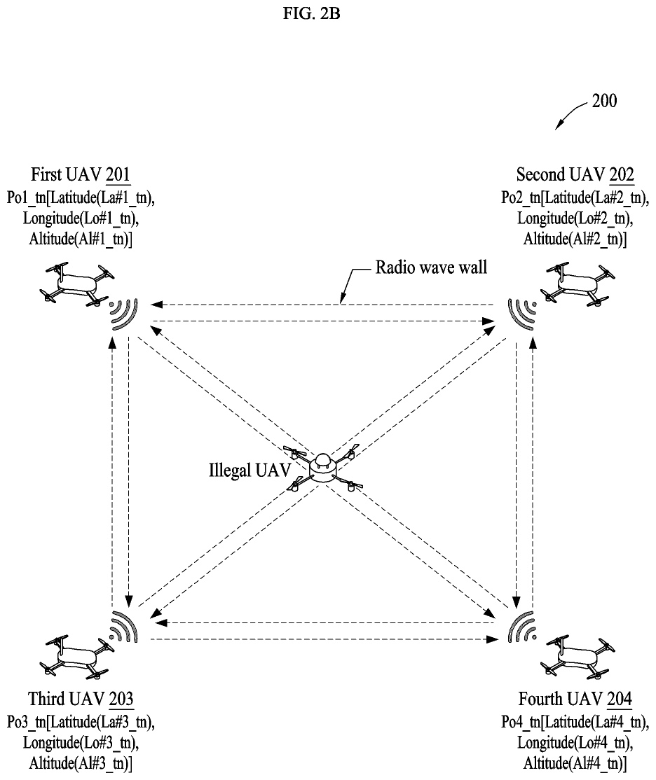

A plurality of reconnaissance UAVs 200 of FIG. 2A may detect an illegal UAV while flying in the reconnaissance airspace in formation, and may include a first reconnaissance UAV and second reconnaissance UAVs. Hereinafter, a method of detecting an illegal UAV will be described based on the first reconnaissance UAV among the plurality of reconnaissance UAVs 200, and the first reconnaissance UAV may include the illegal UAV detection device 100. The second reconnaissance UAVs may also include the same device as the illegal UAV detection device 100 and may detect an illegal UAV. The plurality of reconnaissance UAVs 200 may each detect an illegal UAV while flying in formation.

The illegal UAV detection device 100 may generate a radio wave wall between the plurality of reconnaissance UAVs 200 using one or more wireless signals transmitted and received between the plurality of reconnaissance UAVs 200 including the first reconnaissance UAV and the second reconnaissance UAVs. The concept of the radio wave wall will be described in detail with reference to FIGS. 2A and 2B.

The illegal UAV detection device 100 may determine whether an illegal UAV enters the radio wave wall based on a radio signal strength of a wireless signal received from a second reconnaissance UAV.

The illegal UAV detection device 100 may include a duplexer 110, a radio frequency (RF) transmitter 120, an RF receiver 130, a processor 140, and a memory 150.

The duplexer 110 may be a coupler configured to use one antenna for both transmission and reception. The duplexer 110 may electrically separate a transmission path and a reception path of a wireless signal, and may prevent a wireless signal to be transmitted from entering a receiver and interfering with a reception of another wireless signal. The duplexer 110 may receive a wireless signal via an antenna and output the wireless signal to the RF receiver 130. Also, the duplexer 110 may receive a wireless signal through the RF transmitter 120 and transmit the wireless signal via the antenna.

The RF transmitter 120 may receive a wireless signal from the processor 140 and output the wireless signal to the duplexer 110. The RF receiver 130 may receive a wireless signal from the duplexer 110 and output the wireless signal to the processor 140.

The processor 140 may output a wireless signal including information on the first reconnaissance UAV to the RF transmitter 120. The information on the first reconnaissance UAV may be location information of the first reconnaissance UAV received from a global positioning system (GPS) device and/or a pseudo-noise (PN) code assigned to the first reconnaissance UAV. The processor 140 may output the information on the first reconnaissance UAV by selecting a frequency to be used.

The processor 140 may receive wireless signals from the second reconnaissance UAVs, and may control the first reconnaissance UAV to maximize radio signal strengths of the received wireless signals. For example, the processor 140 may form a beam of an antenna mounted on the first reconnaissance UAV based on reception angles of the wireless signals received from the second reconnaissance UAVs. When a fixed antenna is mounted on the first reconnaissance UAV, the processor 140 may control a flight attitude of the first reconnaissance UAV. Also, the processor 140 may control a location of the antenna mounted on the first reconnaissance UAV based on the radio signal strengths of the wireless signals received from the second reconnaissance UAVs.

The processor 140 may measure in advance the radio signal strengths (for example, a received signal strength indicator (RSSI)) of the wireless signals received from the second reconnaissance UAVs, and may store the radio signal strengths in the memory 150. The processor 140 may measure and store a radio signal strength in advance according to a distance between the first reconnaissance UAV and each of the second reconnaissance UAVs.

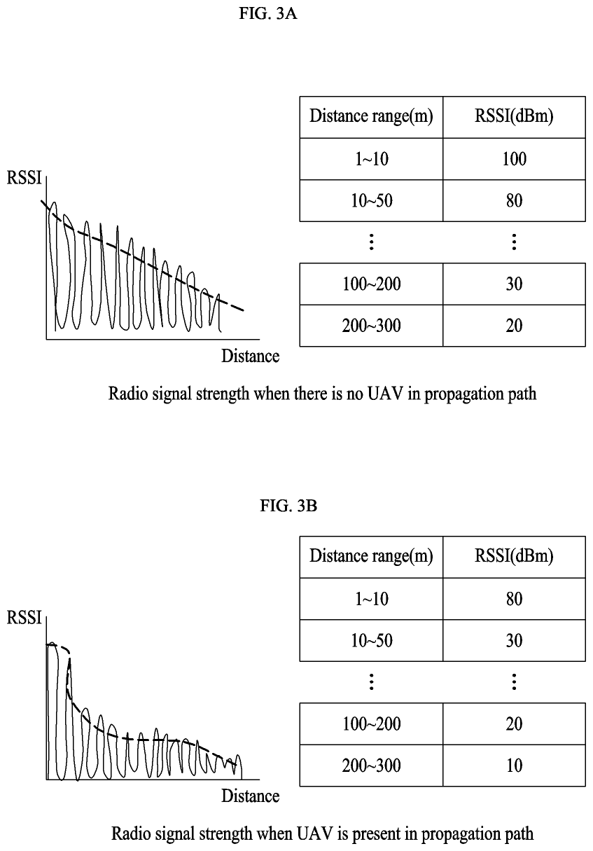

The processor 140 may determine whether the illegal UAV enters the radio wave wall, based on the radio signal strengths of the wireless signals received from the second reconnaissance UAVs. For example, the processor 140 may measure the radio signal strengths of the wireless signals received from the second reconnaissance UAVs. In addition, the processor 140 may calculate an estimated distance, based on information (for example, location information of the second reconnaissance UAVs and/or unique PN codes assigned to the second reconnaissance UAVs) included in the wireless signals received from the second reconnaissance UAVs. The estimated distance may be a distance between the first reconnaissance UAV and each of the second reconnaissance UAVs. The processor 140 may obtain a radio signal strength according to the estimated distance from the memory 150 and may compare a measured radio signal strength to the obtained radio signal strength, to determine whether the illegal UAV enters. An operation of determining whether an illegal UAV enters based on a radio signal strength will be described in detail with reference to FIGS. 3A and 3B.

The processor 140 may process data stored in the memory 150. The processor 140 may execute a computer-readable code (for example, software) stored in the memory 150 and instructions triggered by the processor 140.

The processor 140 may be a data processing device implemented by hardware including a circuit having a physical structure to perform desired operations. For example, the desired operations may include code or instructions included in a program.

For example, the hardware-implemented data processing device may include a microprocessor, a central processing unit (CPU), a processor core, a multi-core processor, a multiprocessor, an application-specific integrated circuit (ASIC), and a field-programmable gate array (FPGA).

The memory 150 may store instructions (or programs) executable by the processor 140. For example, the instructions may include instructions to perform an operation of the processor 140 and/or an operation of each element of the processor 140.

The memory 150 may be implemented as a volatile memory device or a nonvolatile memory device.

The volatile memory device may be implemented as a dynamic random-access memory (DRAM), a static random-access memory (SRAM), a thyristor RAM (T-RAM), a zero capacitor RAM (Z-RAM), or a twin transistor RAM (TTRAM).

The nonvolatile memory device may be implemented as, for example, an electrically erasable programmable read-only memory (EEPROM), a flash memory, a magnetic RAM (MRAM), a spin-transfer torque (STT)-MRAM, a conductive bridging RAM (CBRAM), a ferroelectric RAM (FeRAM), a phase change RAM (PRAM), a resistive RAM (RRAM), a nanotube RRAM, a polymer RAM (PoRAM), a nano floating gate Memory (NFGM), a holographic memory, a molecular electronic memory device), or an insulator resistance change memory.

Hereinafter, a radio wave wall will be described with reference to FIGS. 2A and 2B.

FIG. 2A is a diagram illustrating an operation of reconnaissance UAVs to transmit and receive wireless signals, and FIG. 2B illustrates a radio wave wall generated based on wireless signals transmitted and received between reconnaissance UAVs.

The plurality of reconnaissance UAVs 200 may include a first UAV 201, a second UAV 202, a third UAV 203, and a fourth UAV 204. The above-described first reconnaissance UAV may correspond to the first UAV 201 of FIGS. 2A and 2B, and the above-described second reconnaissance UAVs may correspond to the second UAV 202, the third UAV 203 and the fourth UAV 204 of FIGS. 2A and 2B.

The first UAV 201 may transmit a wireless signal to each of the second UAV 202, the third UAV 203, and the fourth UAV 204 at an assigned transmission time, and may receive a wireless signal from each of the second UAV 202, the third UAV 203, and the fourth UAV 204 at an assigned reception time.

The wireless signal may include location information of each UAV and/or a PN code assigned to each UAV.

First location information that is location information of the first UAV 201 may be Pol_tn[latitude (La#1_tn), longitude (Lo#1_tn), altitude (Al#1_tn)] at time tn, and second location information that is location information of the second UAV 202 may be Po2_tn[latitude (La#2_tn), longitude (Lo#2_tn), altitude (Al#2 tn)] at time tn. Third location information that is location information of the third UAV 203 may be Po3_tn[latitude (La#3_tn), longitude (Lo#3_tn), altitude (Al#3_tn)] at time tn, and fourth location information that is location information of the fourth UAV 204 may be Po4_tn[latitude (La#4_tn), longitude (Lo#4_tn), altitude (Al#4_tn)] at time tn.

The first UAV 201 may obtain the first location information from a GPS and may transmit the first location information to the second UAV 202, the third UAV 203, and the fourth UAV 204. The first UAV 201 may transmit a first PN code that is a unique PN code assigned to the first UAV 201 in response to a failure in reception of the first location information.

The first UAV 201 may transmit the first location information and/or the first PN code using a frequency assigned to the first UAV 201 or through time-division of a common frequency.

The second UAV 202, the third UAV 203, and the fourth UAV 204 may perform the same operation as that of the first UAV 201.

The plurality of reconnaissance UAVs 200 (for example, the first UAV 201, the second UAV 202, the third UAV 203, and the fourth UAV 204) may transmit wireless signals at each assigned transmission time, may receive wireless signals from other UAVs at each assigned reception time, and may generate a radio wave wall between the plurality of reconnaissance UAVs 200.

The radio wave wall may have, for example, a shape of a quadrangle with the plurality of reconnaissance UAVs 200 as vertices. Since the plurality of reconnaissance UAVs 200 are flying together in the reconnaissance airspace and locations of the reconnaissance UAVs 200 change in real time, a shape of the radio wave wall is not limited to a specific figure.

Even if an illegal UAV is not located in a central portion of the radio wave wall, the illegal UAV entering the radio wave wall may be detected.

Hereinafter, a radio signal strength in an example in which there is an illegal UAV that enters the above-described radio wave wall will be described with reference to FIGS. 3A and 3B.

FIGS. 3A and 3B are diagrams illustrating radio signal strengths of wireless signals based on a propagation path.

FIG. 3A illustrates a radio signal strength measured when there is no UAV in the propagation path, and FIG. 3B illustrates a radio signal strength measured when a UAV is present in the propagation path.

In an example, when there is no illegal UAV in a propagation path of a wireless signal, a radio signal strength of the wireless signal may be attenuated in inverse proportion to a transmission distance. In another example, when an illegal UAV is present in a propagation path of a wireless signal, a radio signal strength of the wireless signal may be rapidly attenuated in a specific distance range. The plurality of reconnaissance UAVs 200 may compare a measured radio signal strength to a radio signal strength that is pre-stored based on a distance, and may determine whether an illegal UAV enters.

A radio signal strength of a wireless signal may be, for example, a value of an RSSI calculated using Equation 1 shown below.

$${P}_{r} ( dBm ) = {P}_{t} ( dBm ) + {G}_{t} ( dBm ) + {G}_{r} ( dB ) - L ( dB ) \\ L ( dB ) = 20 {log ( \frac{4 π d}{λ} )}^{2} \qquad [ Equation 1 ]$$

In Equation 1, Pᵣ, which is a radio signal strength of a received wireless signal and denotes received power, Pₜ denotes transmitted power, Gₜ denotes a transmission antenna gain, Gᵣ denotes a reception antenna gain, L denotes a propagation loss, d denotes a distance between a transmission antenna and a reception antenna, and λ denotes a frequency wavelength.

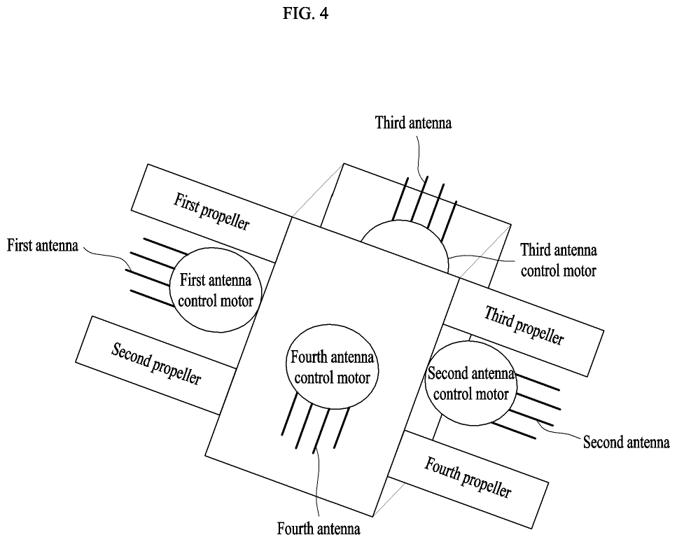

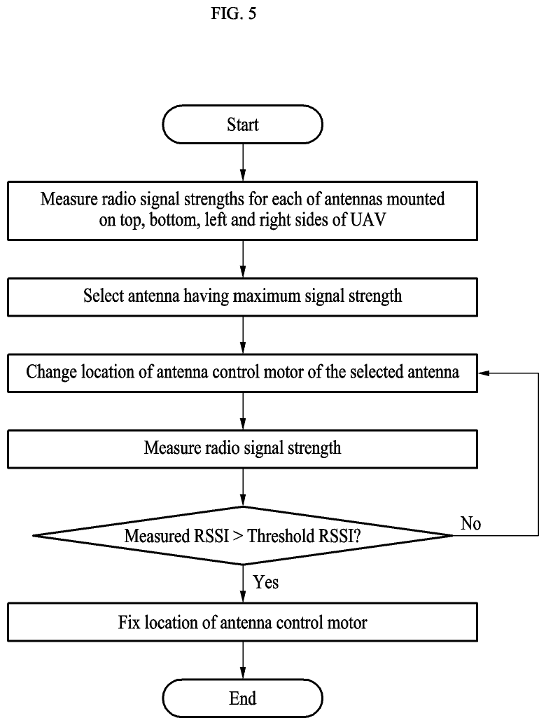

Hereinafter, a structure and a control operation of a reconnaissance UAV constituting a radio wave wall will be described with reference to FIGS. 4 and 5.

FIG. 4 illustrates an example of a reconnaissance UAV 200 of FIG. 2A.

To construct and maintain a radio wave wall between the plurality of reconnaissance UAVs 200, each of the reconnaissance UAVs 200 may include antennas and antenna control motors on top, bottom, left and right sides thereof.

The first reconnaissance UAV may include a first antenna, a second antenna, a third antenna, a fourth antenna, a first antenna control motor configured to control the first antenna, a second antenna control motor configured to control the second antenna, a third antenna control motor configured to control the third antenna, and a fourth antenna control motor configured to control the fourth antenna. In addition, the second reconnaissance UAVs may include the same antennas and antenna control motors as those of the first reconnaissance UAV.

The first reconnaissance UAV may include propellers, for example, a first propeller, a second propeller, a third propeller, and a fourth propeller. The propellers, for example, the first propeller to the fourth propeller, may be devices that apply thrust to the first reconnaissance UAV, and may be fixed to a body of the first reconnaissance UAV. A number of propellers is not limited to four, and may be adjusted based on an engine output and a size of the first reconnaissance UAV. In addition, the second reconnaissance UAVs may include the same propellers as those of the first reconnaissance UAV.

FIG. 5 is a flowchart illustrating a control operation of a reconnaissance UAV.

The illegal UAV detection device 100 may control the first reconnaissance UAV to maximize radio signal strengths of wireless signals received from the second reconnaissance UAVs.

The illegal UAV detection device 100 may measure a radio signal strength of a wireless signal received by each of the first antenna, the second antenna, the third antenna, and the fourth antenna of the first reconnaissance UAV. The illegal UAV detection device 100 may select an antenna to receive a wireless signal having a maximum radio signal strength. The illegal UAV detection device 100 may change a location of an antenna control motor of the selected antenna, and may measure a radio signal strength of a wireless signal received via the antenna corresponding to the antenna control motor of which the location is changed. If the measured radio signal strength (for example, a value of an RSSI) is less than a preset threshold radio signal strength, the location of the antenna control motor may be changed again and the radio signal strength may be measured. If the measured radio signal strength is greater than the preset threshold radio signal strength, the location of the antenna may be set by fixing the location of the antenna control motor.

The illegal UAV detection device 100 may form a beam of an antenna mounted on the first reconnaissance UAV based on reception angles of the wireless signals received from the second reconnaissance UAVs. When a fixed antenna is mounted on the first reconnaissance UAV, the illegal UAV detection device 100 may control a flight attitude of the first reconnaissance UAV.

Since the first reconnaissance UAV continues to fly in a reconnaissance airspace, the illegal UAV detection device 100 may control the first reconnaissance UAV at regular intervals by setting a timer, to maximize a radio signal strength of a received wireless signal.

The second reconnaissance UAVs may also be controlled similarly to the first reconnaissance UAV by the same device as the illegal UAV detection device 100.

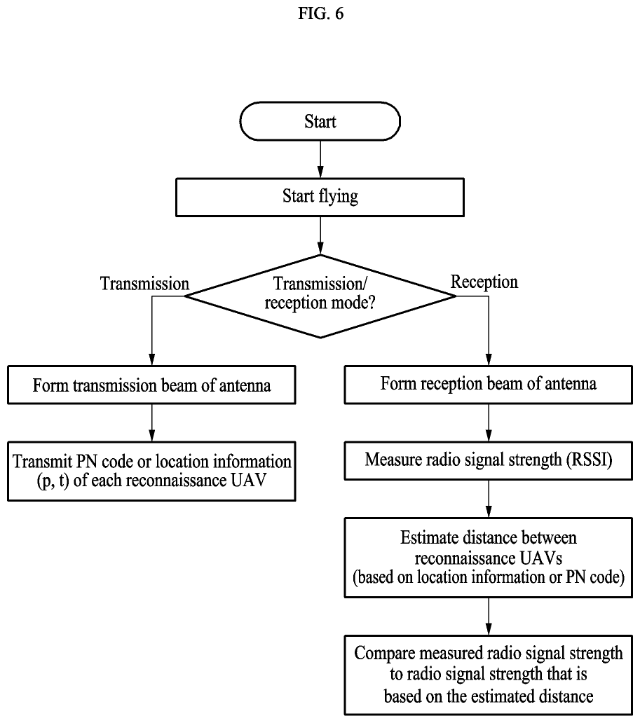

FIG. 6 is a diagram illustrating an operation of detecting an illegal UAV that enters a radio wave wall.

A plurality of reconnaissance UAVs 200 including a first reconnaissance UAV and second reconnaissance UAVs may start flying to monitor a reconnaissance airspace.

The first reconnaissance UAV may transmit location information of the first reconnaissance UAV and/or a PN code assigned to the first reconnaissance UAV by forming a beam of an antenna.

The first reconnaissance UAV may receive location information of the second reconnaissance UAVs and/or PN codes assigned to the second reconnaissance UAVs from the second reconnaissance UAVs by forming a beam of the antenna.

The second reconnaissance UAVs may perform the same operation as that of the first reconnaissance UAV. The plurality of reconnaissance UAVs 200 including the first reconnaissance UAV and the second reconnaissance UAVs may generate a radio wave wall between the plurality of reconnaissance UAVs 200 through a transmission and reception of wireless signals.

The first reconnaissance UAV may measure radio signal strengths (for example, a value of an RSSI) of wireless signals received from the second reconnaissance UAVs.

The first reconnaissance UAV may calculate an estimated distance based on information (for example, the location information of the second reconnaissance UAVs and/or unique PN codes assigned to the second reconnaissance UAVs) included in the wireless signals received from the second reconnaissance UAVs. The estimated distance may be a distance between the first reconnaissance UAV and each of the second reconnaissance UAVs.

The first reconnaissance UAV may compare a measured radio signal strength to a radio signal strength that is based on the estimated distance, and may determine whether an illegal UAV enters the radio wave wall.

The second reconnaissance UAVs may perform the same operation as that of the first reconnaissance UAV, and each of the plurality of reconnaissance UAVs may detect an illegal UAV.

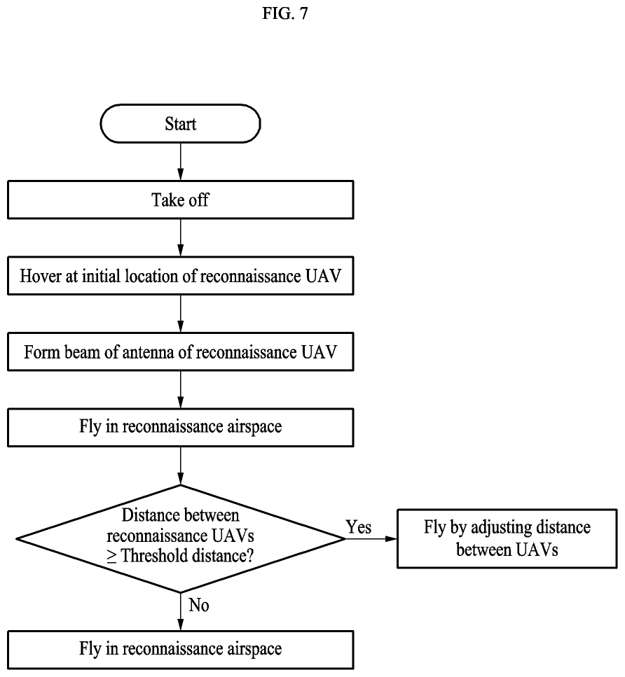

Hereinafter, a method by which UAVs fly while maintaining a radio wave wall will be described with reference to FIG. 7.

FIG. 7 is a flowchart illustrating a flight method of reconnaissance UAVs.

A plurality of reconnaissance UAVs 200 including a first reconnaissance UAV and second reconnaissance UAVs may start flying to monitor a reconnaissance airspace.

The plurality of reconnaissance UAVs 200 may perform hovering to maintain a specific altitude and a specific distance between reconnaissance UAVs.

The plurality of reconnaissance UAVs 200 may transmit and receive wireless signals to and from each other by controlling antennas mounted on the reconnaissance UAVs 200, and may generate a radio wave wall between the plurality of reconnaissance UAVs 200. The plurality of reconnaissance UAVs 200 may fly in the reconnaissance airspace while maintaining the radio wave wall.

The second reconnaissance UAVs may adjust a distance between the first reconnaissance UAV and each of the second reconnaissance UAVs based on a radio signal strength of a wireless signal received from the first reconnaissance UAV to maintain the radio wave wall. For example, the second reconnaissance UAVs may measure a distance to the first reconnaissance UAV and may compare the distance to a pre-stored threshold distance. The distance may be measured by comparing location information of the first reconnaissance UAV to location information of the second reconnaissance UAVs or by processing a PN code assigned to the first reconnaissance UAV. When the distance to the first reconnaissance UAV is greater than the threshold distance, the second reconnaissance UAVs may maintain the radio wave wall by adjusting the distance to the first reconnaissance UAV to decrease. When the distance to the first reconnaissance UAV is less than the threshold distance, the second reconnaissance UAVs may fly in the reconnaissance airspace without a change.

The first reconnaissance UAV may perform the same operation as those of the second reconnaissance UAVs, and the plurality of reconnaissance UAVs 200 may interact and fly to detect an illegal UAV.

The components described in the example embodiments may be implemented by hardware components including, for example, at least one digital signal processor (DSP), a processor, a controller, an application-specific integrated circuit (ASIC), a programmable logic element, such as a field programmable gate array (FPGA), other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The example embodiments described herein may be implemented using a hardware component, a software component and/or a combination thereof. A processing device may be implemented using one or more general-purpose or special-purpose computers, such as, for example, a processor, a controller and an arithmetic logic unit (ALU), a digital signal processor (DSP), a microcomputer, an FPGA, a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

The above-described devices may be configured to act as one or more software modules in order to perform the operations of the above-described examples, or vice versa.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

What is claimed is:

1. A method of detecting an illegal unmanned aerial vehicle (UAV), the method comprising:
generating a radio wave wall between a plurality of reconnaissance UAVs using one or more wireless signals transmitted and received between the plurality of reconnaissance UAVs, the plurality of reconnaissance UAVs comprising a first reconnaissance UAV and second reconnaissance UAVs; and
determining whether an illegal UAV enters the radio wave wall based on radio signal strengths of wireless signals received from the second reconnaissance UAVs.

2. The method of claim 1, further comprising:
controlling the first reconnaissance UAV to maximize the radio signal strengths of the wireless signals received from the second reconnaissance UAVs.

3. The method of claim 2, wherein the controlling of the first reconnaissance UAV comprises controlling the first reconnaissance UAV by forming a beam of an antenna mounted on the first reconnaissance UAV based on reception angles of the wireless signals received from the second reconnaissance UAVs.

4. The method of claim 2, wherein the controlling of the first reconnaissance UAV comprises controlling a flight attitude of the first reconnaissance UAV including a fixed antenna.

5. The method of claim 2, wherein the controlling of the first reconnaissance UAV comprises controlling a location of an antenna mounted on the first reconnaissance UAV based on the radio signal strengths of the wireless signals received from the second reconnaissance UAVs.

6. The method of claim 1, wherein
the determining of whether the illegal UAV enters the radio wave wall comprises calculating an estimated distance based on information included in the wireless signals received from the second reconnaissance UAVs, and
the estimated distance is a distance between the first reconnaissance UAV and each of the second reconnaissance UAVs.

7. The method of claim 6, wherein the information comprises at least one of location information of the second reconnaissance UAVs and unique pseudo-noise (PN) codes assigned to the second reconnaissance UAVs.

8. The method of claim 6, wherein the determining of whether the illegal UAV enters the radio wave wall further comprises measuring the radio signal strengths of the wireless signals received from the second reconnaissance UAVs.

9. The method of claim 8, wherein the determining of whether the illegal UAV enters the radio wave wall further comprises comparing a measured radio signal strength to a radio signal strength that is based on the estimated distance, and determining whether the illegal UAV enters the radio wave wall.

10. A device for detecting an illegal unmanned aerial vehicle (UAV), the device comprising:
a memory configured to store at least one instruction; and
a processor configured to execute the instruction,
wherein when the instruction is executed, the processor is configured to:
generate a radio wave wall between a plurality of reconnaissance UAVs using one or more wireless signals transmitted and received between the plurality of reconnaissance UAVs, the plurality of reconnaissance UAVs comprising a first reconnaissance UAV and second reconnaissance UAVs; and
determine whether an illegal UAV enters the radio wave wall based on radio signal strengths of wireless signals received from the second reconnaissance UAVs.

11. The device of claim 10, wherein the processor is configured to control the first reconnaissance UAV to maximize the radio signal strengths of the wireless signals received from the second reconnaissance UAVs.

12. The device of claim 11, wherein the processor is configured to control the first reconnaissance UAV by forming a beam of an antenna mounted on the first reconnaissance UAV based on reception angles of the wireless signals received from the second reconnaissance UAVs.

13. The device of claim 11, wherein the processor is configured to control a flight attitude of the first reconnaissance UAV including a fixed antenna.

14. The device of claim 11, wherein the processor is configured to control a location of an antenna mounted on the first reconnaissance UAV based on the radio signal strengths of the wireless signals received from the second reconnaissance UAVs.

15. The device of claim 10, wherein
the processor is configured to calculate an estimated distance based on information included in the wireless signals received from the second reconnaissance UAVs, and
the estimated distance is a distance between the first reconnaissance UAV and each of the second reconnaissance UAVs.

16. The device of claim 15, wherein the information comprises at least one of location information of the second reconnaissance UAVs and unique pseudo-noise (PN) codes assigned to the second reconnaissance UAVs.

17. The device of claim 15, wherein the processor is configured to measure the radio signal strengths of the wireless signals received from the second reconnaissance UAVs.

18. The device of claim 17, wherein the processor is configured to compare a measured radio signal strength to a radio signal strength that is based on the estimated distance, and to determine whether the illegal UAV enters the radio wave wall.

19. A flight method of a reconnaissance unmanned aerial vehicle (UAV), the flight method comprising:
generating a radio wave wall between a plurality of reconnaissance UAVs using one or more wireless signals transmitted and received between the plurality of reconnaissance UAVs, the plurality of reconnaissance UAVs comprising a first reconnaissance UAV and second reconnaissance UAVs; and
adjusting a distance between the first reconnaissance UAV and each of the second reconnaissance UAVs based on a radio signal strength of a wireless signal received from the first reconnaissance UAV to maintain the radio wave wall.
